(19) United States
(12) Patent Application Publication
(10) Pub. No.: US 2025/0127154 A1
(43) Pub. Date: Apr. 24, 2025

(54) FISHING SINKER

(71) Applicant: DAFOUR LIMITED, Auckland (NZ)

(72) Inventor: David Craeme Bruce LENDEN, Hamilton (NZ)

(21) Appl. No.: 18/570,013

(22) PCT Filed: Jul. 16, 2021
(86) PCT No.: PCT/NZ2021/050108

§ 371 Date: Dec. 13, 2023

(30) Foreign Application Priority Data
Jun. 17, 2021 (NZ) 777313

(51) Int. Cl. A01K 95/02

(52) U.S. Cl. CPC A01K 95/02

(57) ABSTRACT

A fishing sinker including a weight, an elongate member extending from the weight, a proximate end of the elongate member attached to the weight, and an attachment point at an opposite distal end of the elongate member for attaching a fishing line is disclosed. The elongate member is configured to receive a baited hook from a side of the elongate member.

### FIELD OF INVENTION

The invention relates to a fisher sinker for weighting a fishing line.

### BACKGROUND TO THE INVENTION

A fishing sinker is attached to a fishing line to weight the line for casting with a fishing rod and to descend to the bottom of the sea, river or lake being fished.

A sinker is attached at or near to an end of the line and typically a baited hook is attached to the line at a distance along the line from the sinker. As the line is cast through the air the bait can swing around the sinker which can greatly impede the efficiency of the cast and therefore the distance the fishing line reaches.

Due to its weight a sinker typically impedes the retrieval of a fishing line, when retrieving a line to check a bait or retrieving a hooked fish. A sinker can drag along the bottom of the sea, river or lake during retrieval and may be snagged or caught in rough terrain. This can cause the line to snap, resulting in the loss of the sinker and attached fishing tackle.

### OBJECT OF THE INVENTION

It is an object of the invention to provide a sinker that addresses one or more of the above-mentioned disadvantages, or that at least provides the public with a useful choice.

### SUMMARY OF THE INVENTION

According to a first aspect of the invention, there is provided a fishing sinker comprising a weight, an elongate member extending from the weight, a proximate end of the elongate member attached to the weight, and an attachment point at an opposite distal end of the elongate member for attaching a fishing line, wherein the elongate member is configured to receive a baited hook from a side of the elongate member.

In some embodiments, the weight is a solid unitary mass without any longitudinal aperture therethrough.

In some embodiments, the mass of the weight is much greater than the mass of the elongate member so that a centre of mass of the sinker in a longitudinal direction of the sinker is at the weight.

In some embodiments, the mass of the elongate member is less than half the mass of the weight.

In some embodiments, the mass of the elongate member is less than 25% of the mass of the weight.

In some embodiments, the length of the elongate member extending from the is 80 mm to 140 mm, or 90 mm to 130 mm, or 100 mm to 120 mm.

In some embodiments, the weight presents a nose cone shape to provide an aerodynamic profile.

In some embodiments, the elongate member presents a laterally facing open recess for receiving a baited hook from a side of the elongate member.

In some embodiments, the elongate member comprises a tubular part attached to the weight and an elongate part extending from the tubular part, the elongate part presenting the recess for receiving a baited hook from a side of the elongate member.

In some embodiments, the cross section of the elongate part corresponds with a portion of the cross section of the tubular part.

In some embodiments, the elongate member is formed from length of tube with a side portion removed, the tubular part of the elongate member comprising a full cross section of the tube and the elongate part comprising a portion of the cross section of the tube.

In some embodiments, the elongate part comprises one-quarter to three-quarters of the cross section of the tubular part and is preferably one-half of the cross section of the tubular part.

In some embodiments, the tube comprises a circular cross section or a square cross section.

In some embodiments, the distal end of the elongate member is open.

In some embodiments, the elongate member is configured to operate as a vane, to cause the sinker to rise to the surface during retrieval.

In some embodiments, the tubular part extends from the weight to present a rearwardly facing recess for receiving a fish attractant.

In some embodiments, a sponge received in the rearwardly facing recess for receiving a liquid fish attractant.

In some embodiments, the rearwardly facing recess has a volume of 1 to 5 millilitres

In some embodiments, the attachment point is an aperture through the elongate member at the distal end of the elongate member.

In some embodiments, the weight has a mass of 2 to 8 ounces.

In some embodiments, the elongate member is formed from aluminium.

In some embodiments, the sinker comprises a hook attached to the sinker to trail slightly behind or towards a weight end of the sinker during retrieval to configure the sinker as a fishing lure during retrieval.

In some embodiments, the hook is attached to the attachment point by a line separate from a main fishing line attached to the attachment point during use.

According to a second aspect of the invention, there is provided a method of fishing using a sinker according to the first aspect of the invention. The method comprises:
attaching a fishing line to the attachment point with a hook attached to the line or a secondary line attached to the sinker, and applying bait to the hook;
placing the baited hook and the sinker on the elongate member from a side of the elongate member,
wrapping tape with dissolvable adhesive around the hook and bait and elongate member to secure the hook and bait to the sinker,
casting the sinker with attached baited hook a distance into a body of water using a fishing rod and reel, whereby the sinker sinks to the bottom of the body of water and the tape adhesive dissolves in the water, allowing the baited hook to release from the sinker.

In some embodiments, the method includes retrieving the line, hook and sinker using the rod and reel, causing the sinker to lift to the surface of the water during retrieval.

In some embodiments, the tape has the adhesive (gum) applied to one side and wrapping the tape around the elongate member adheres the tape to itself to attach the baited hook to the elongate member. The adhesive may be activated by wetting. Preferably the tape is biodegradable. Preferably the tape is gummed paper tape.

According to a third aspect of the invention, there is provided a method for manufacturing a sinker according to the first aspect of the invention. The method comprises:
providing a parent length of tube, and cutting the parent tube into pieces, wherein each piece forms the elongate member,
removing a side portion from the piece of tube to form the elongate member comprising a tubular part and an elongate part,
adding the attachment point to the distal end of the elongate member;
attaching the tubular part of the elongate member to the weight.

In some embodiments, the method step of attaching the tubular part to the weight comprises placing an end portion of the tubular part in a mould and poring molten material into the mould to form the weight moulded to the tubular part.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings, in which:

FIG. 1 is a front perspective view of a fishing sinker according to an embodiment of the present invention.

FIG. 2 is a rear perspective view of the fishing sinker of FIG. 1.

FIG. 3 is a side perspective view of the fishing sinker of FIG. 1.

FIG. 4 is a rear view of the fishing sinker of FIG. 1.

FIG. 5 illustrates the sinker of Figure being cast from a fishing rod and reel.

FIG. 6 illustrates the sinker of FIG. 1 being retrieved.

FIG. 7 illustrates the sinker of FIG. 1 with a hook attached to be configured for use as a lure during retrieval.

### BRIEF DESCRIPTION OF PREFERRED EMBODIMENTS OF THE INVENTION

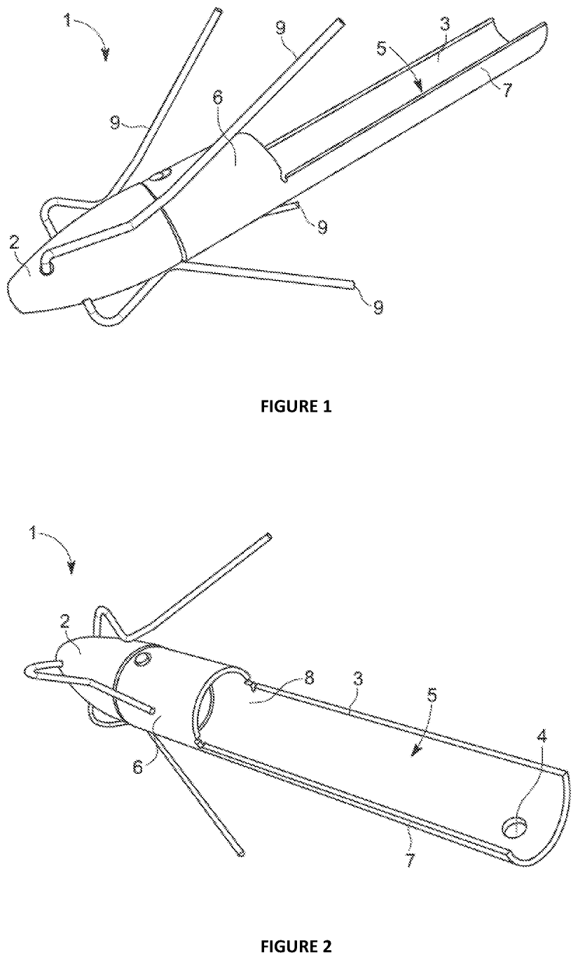

A fishing sinker according to an embodiment of the present invention is shown in FIGS. 1 to 4.

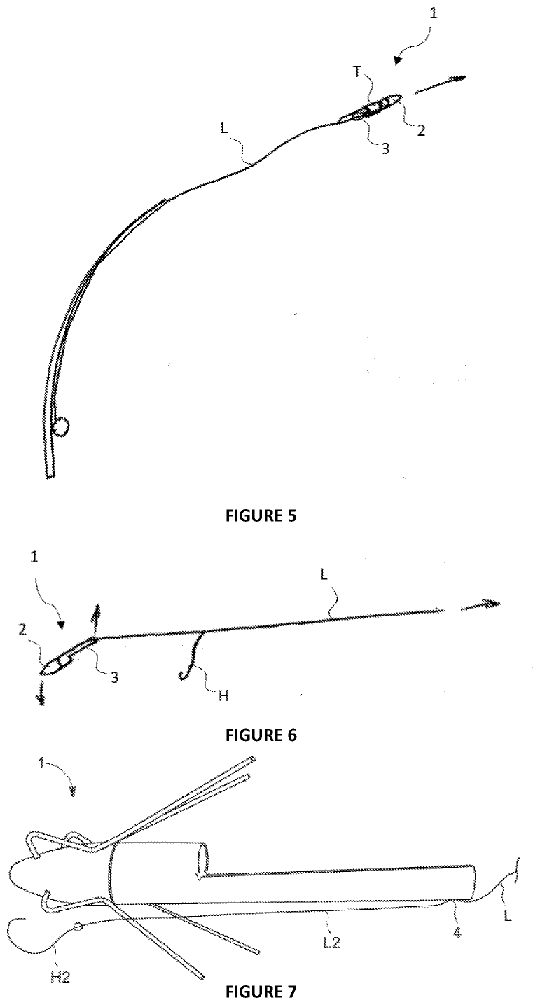

The fishing sinker 1 comprises a weight 2 and an elongate member 3 extending from the weight 2. A proximate end of the elongate member 3 is attached to the weight 2. An attachment point 4 (refer FIG. 2) for attaching the sinker 1 to a fishing line (L in FIGS. 5 and 6) is provided at an opposite distal end of the elongate member. In the illustrated embodiment the attachment point is an aperture 4 through the elongate member 3 at the distal end of the elongate member.

According to the present invention the elongate member 3 is configured to receive a baited hook from a side of the elongate member. In use, a baited hook (e.g. H in FIG. 6) attached to the fishing line L or a hook attached to the sinker via a secondary line (e.g. hook H2 and line L2 in FIG. 7) is placed on a side of the elongate member and is retained on the elongate member by a paper tape material (T in FIG. 5). The width of the elongate member is sufficient to allow the baited hook to rest thereon. A person using the sinker 1 wraps the paper tape T around the elongate member and over the baited hook H. The paper tape has an adhesive applied to one side. The adhesive may be activated by moisture/liquid (water). The adhesive sticks to an opposite side of the tape as the tape is wound around the sinker and over the baited hook to hold the bait and hook on the elongate member. Once the sinker has landed in water and sinks to the bottom of the sea, river or lake, the tape adhesive dissolves so that the tape comes off the sinker to allow the bait to float away from the sinker 1 which anchors itself by its weight to the bottom. The tape with adhesive is preferably biodegradable. A suitable available paper tape is plain natural Kraft water activated gummed paper tape. The adhesive/gum is vegetable glue.

FIG. 5 illustrates the sinker in use being casted with a baited hook attached to the elongate member with paper tape 6. The elongate member 3 provides a means to which the hook H and bait may be attached, to prevent the hook and bait swinging in the air impeding the flight of the sinker 1 during casting.

Preferably the elongate member is configured to provide a laterally facing recess 5 for receiving the baited hook H from a side of the elongate member 3. In use, the hook H attached to the fishing line L or secondary line is placed in the open recess 5 and is retained on the elongate member 3 by the paper tape material as described above. The baited hook is located on the elongate member between the weight 2 and the line attachment point 4. The lateral facing open recess 5 preferably extends for a substantial length of the elongate member extending from the rear of the weight. For example, the open recess extends for at least ⅔ of the length of the elongate member extending from the rear of the weight, or a full length of the elongate member extending from the rear of the weight.

In the preferred illustrated embodiment, the elongate member 3 comprises a tubular part 6 attached to the weight 2 and an elongate part 7 extending from the tubular part 6. The elongate part 6 presents the laterally open recess 5 for receiving the baited hook from a side of the elongate member 3. The elongate part extends for a substantial length of the elongate member, for example the elongate part extends for at least ⅔ of the length of the elongate member.

In a preferred embodiment the elongate member 3 is formed from a length/piece of tube with a side portion of the tube removed to form the elongate portion 7 of the elongate member 3. The tubular part 6 and the elongate part 7 are integrally formed together. The tubular part 6 of the elongate member comprises a full cross section of the tube and the elongate part comprises a portion of the cross section of the tube. As shown in the end view of FIG. 4, the cross section of the elongate part 7 corresponds with a portion of the cross section of the tubular part 6. In the illustrated embodiment, the cross section of the elongate part is one-half of the cross section of the tubular part, i.e. the tubular part has a circular wall and the elongate part has a semi-circular wall. The cross section of the tubular part may be one-quarter to three-quarters of the cross section of the tubular part. While the illustrated embodiment comprises a circular wall, the elongate member may be formed with an alternative shape. For example, the elongate member may be formed from a length of tube with a square (box) section. The box section may be cut on a line (e.g. centreline) across flats of the square section to present an elongate part with a long side in between two short sides or may be cut (e.g. across corners) to present a ‘V’ shaped recess.

The elongate member may be formed from a length of aluminium tube, or a plastic tube such as a PVC tube, with a side portion removed as described above. Aluminium is a preferred material due to its durability and also to provide a further option as a fishing lure, as described in more detail below.

The lateral recess presented by the elongate member allows for the baited hook to be easily received on the elongate member and is partially covered or surrounded by the elongate member on one side. This arrangement simplifies the task of attaching the hook to the sinker 1 as the hook with bait can be easily placed in the recess before wrapping the hook with bait and the elongate member with the paper tape T. Furthermore, the recess helps to provide for an aerodynamic assembly.

As best shown in FIGS. 1 and 2, the distal end of the elongate member 3 is open. The lateral facing recess 5 is therefore also open at the distal end of the elongate member. This further aids to the aerodynamic form of the sinker. In the preferred illustrated example, the width of the elongate member 3 is the same as the width of the weight 2. The elongate member is without any end wall at the distal end of the elongate member so that the lateral recess 5 is open to the side and rear (facing the line L in use).

To further assist with the aerodynamic form of the sinker 1 the weight is formed as a solid unitary mass. This means the weight does not have any longitudinally extending aperture or slot through the weight. There is no opening in the weight between the front of the weight and the elongate member attached to the rear of the weight.

As shown in the Figures, the weight is preferably formed with a nose cone shape, much like the nose cone of an aircraft or high velocity projectile (a bullet) to provide an aerodynamic profile. The mass of the weight is much greater than the mass of the elongate member so that a centre of mass of the sinker in a longitudinal direction of the sinker is located within a longitudinal length of the weight 2. For example, the mass of the elongate member is less than half the mass of the weight or is less than 25% of the mass of the weight. By example, for an aluminium member 3 and lead weight 2, the weight 2 may have a mass of around 2 to 8 ounces, whereas the weight of the elongate member 2 may be around 10 grams or less. This illustrated embodiment has a lead weight with a mass of about 2.5 ounces and an elongate member formed from a length of aluminium tube with an outside diameter of about 20 mm and a wall thickness of about 1 mm with a weight of about 10 to 15 grams. The mass of the weight is at least four times, or at least 5 times the mass of the elongate member 3. The elongate member is made from a material that has a density much less than the density of the material forming the weight. For example, the weight is formed from lead and the elongate member is formed from aluminium or plastic material such as PVC, or a composite material such as carbon fibre. The density of the material forming the elongate member may be less than 30% of the density of the material forming the weight.

The length of the elongate member extending from the weight is important for the correct flight of the sinker 1 during casting. If the elongate member is too long, the sinker may be caused to tumble or ‘helicopter’ through the air, which negatively impacts the flight and therefore distance the sinker can reach during casting. The inventor has found a length of up to around 140 mm operates well. With much longer lengths the sinker tumbles during flight. The length of the elongate member 3 extending from the weight should be long enough to accommodate the baited hook without protruding from the distal end of the elongate. The elongate member should have minimum length of 50 to 100 mm to receive the baited hook.

The sinker with above described features and with the baited hook attached to the elongate member can achieve casting distances far exceeding present sinkers. The inventor has proved extraordinary casting distances, of up to 200 m. The casting distance using conventional sinkers achieved by experienced anglers is typically less than 100 m.

When retrieving a line with hook and sinker a conventional sinker typically drags along the bottom of the sea, especially when fishing by casting from a shoreline (e.g. ‘surfcasting’ from a beach or fishing from a rocky headland). The inventor has found a surprising further benefit of the sinker 1 is that the sinker, due to its particular configuration, tends to rise to the surface of the water during retrieval. Since the weight 2 is much heavier than the elongate member 3, and with the fishing line L attached to the attachment point 4 at the end of the elongate member 3 distal from the weight 2, the weight 2 tends to hang below the distal end of the elongate member 3, such that the elongate member 3 tilts upwards towards its distal end, as illustrated in FIG. 6. As shown in FIG. 6, when retrieving the sinker, the open lateral recess tends to be oriented downwards. As the line is received, the upward inclination of the sinker 1 causes the sinker 1 to lift and rise to the surface of the water during typical line retrieval speeds. The upwardly inclined elongate member 3 operates as a vane to lift as it is pulled through the water. This prevents or reduces the chance of the sinker or fishing tackle/line being snagged or caught on rough terrain. It is hypothesized that to ensure the sinker lifts, the elongate member 3 should have a length extending from the weight 2 of at least 80 mm. If the elongate member is too much shorter, the line attachment point 4 is too close to the weight 2 and/or the elongate member 3 is too short to operate as a vane. The width of the elongate member 3 may be in the range of 10 mm to 30 mm, or 15 mm to 25 mm, or about 20 mm. The width of the elongate member is constant along its length. For effective operation during casting and during retrieval, the elongate member should have a length extending from the weight of about 80 mm to 140 mm, or 90 mm to 130 mm, or 100 mm to 120 mm.

In some embodiments, the sinker includes a recess for receiving a fish attractant. In the illustrated embodiment, the tubular part 6 of the elongate member extends from the weight to present a rearwardly facing recess 8 for receiving a fish attractant. In some embodiments, a sponge material (not shown) is received in the recess 8 for receiving a liquid fish attractant. In use, an angler dispenses liquid fish attractant onto the sponge so that the attractant soaks into the sponge. In use with the sinker 1 submerged, the liquid attractant is slowly released from the sponge material into the water in the vicinity of the baited hook. The rearwardly facing recess may have a volume of around 1 to 5 millilitres.

A method of fishing using a sinker according to the present invention is now described. A fishing line is attached to the sinker 1 is via the attachment point 3. The line has a hook H attached to the line at a distance from the sinker, for example 0.5 to 2 meters. Preferably the hook is attached to the main line L by a loop or length of line extending from the main line L to the hook as shown in FIG. 6 (ledger rig). Preferably the loop or length of line extending between the main line L and the hook H is long enough so that the hook H can reach to the sinker to be placed on the elongate member 3 with the main line extending from the attachment point taut so that the main line can extend under tension from the attachment point 4 during casting without pulling the hook and bait off the elongate member. Alternatively, or additionally a hook H2 may be attached to the attachment point 4 via a secondary line L2 (FIG. 7). In a further alternative, the line L may be threaded through the attachment point 4 and with the hook H attached to an end of the line (running sinker). Bait is attached to the hook(s). The baited hook H is placed on the elongate member 3 from a side of the elongate member, and/or the baited hook H2 is placed on the elongate member 3. The hook and bait is attached to the elongate member using paper tape. The paper tape may be wetted to activate adhesive on one side of the tape. Wrapping the tape around the elongate member adheres the tape to itself to attach the baited hook to the elongate member. The sinker with attached bait is then cast a distance into a body of water, e.g. the sea, using a typical fishing rod and reel in the usual way. The sinker sinks to the bottom of the body of water and the tape adhesive dissolves in the water, so that the tape unwraps in water allowing the baited hook(s) to release from the sinker. When retrieving the line, hook and sinker, the line is recovered using the rod and reel and the sinker is caused to lift to the surface of the water during recovery, thereby avoiding snags and reducing the apparent weight of the sinker.

A further benefit of the sinker according to the present invention is that by recovery to the surface, the sinker 1 can operate as a fishing lure during retrieval. The sinker 1 can appear to fish as a fish swimming on the surface and can therefore attract fish to attack the sinker 1. To benefit from this affect as a lure, the sinker 1 may be provided with a hook attached to the sinker 1 to trail slightly behind or towards a weight end of the sinker 1. FIG. 7 illustrates a hook H2 attached to the attachment point 4 via a short secondary line L2 separate from the main fishing line L to position the hook H2 near to the weight end of the sinker 1 to configure the sinker as a lure during retrieval. Alternatively, the hook H may be attached to the main line to hang near to the weight end of the sinker during retrieval. Additional attributes to attract fish may be applied to the elongate body to act as a lure. For example, an aluminium body presents a reflective surface which can give fish the appearance of a fish. Alternatively, or additional a shiny/colorful coating or label may be provided to a side or sides of the elongate body 3.

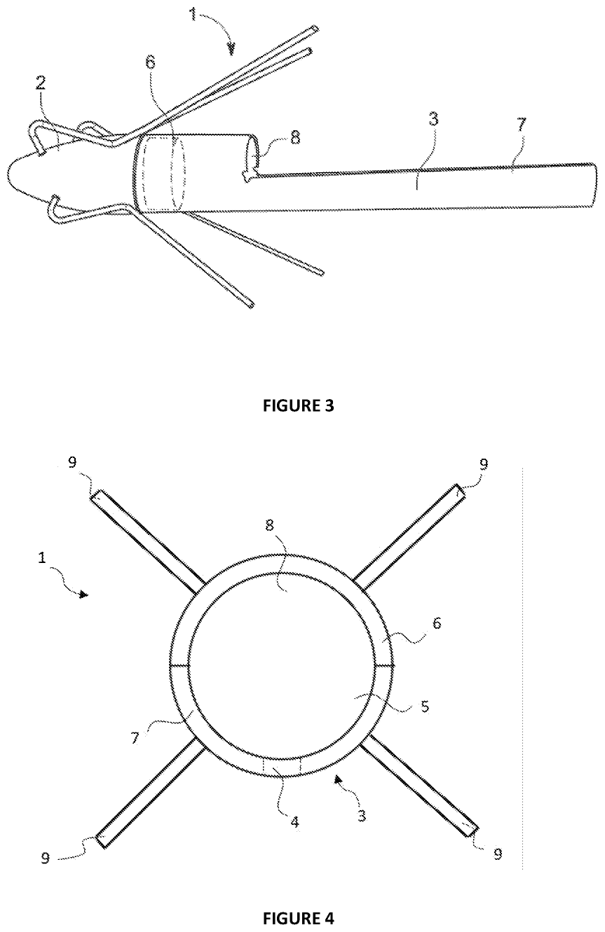

As described above, in some embodiments, the elongate member is made from a length of tube. Many sinkers according to the present invention may be made by cutting a parent length of tube into pieces, each of the desired length for the elongate member. A side piece may then be cut from each piece, to form the elongate member 3 comprising the tubular part 6 and the elongate part 7. The attachment point 4 may be added to the end of the elongate member after cutting the side out of the tube. In an alternative embodiment the elongate member may be injection moulded from a plastic material. To attach the weight 2 to the elongate member preferably an end of the elongate member is inserted into a mould and molten material (such as lead) is poured into the mould to form the weight moulded to the end of the elongate member 3. The elongate member 3 may have one or more features to key into the moulded material of the weight. For example, one or more holes may be provided through the wall of the tubular part 6 for the weight material to flow when molten. A portion of the weight may extend into the end of the elongate member, as shown by hidden detail in FIG. 3.

The illustrated embodiment includes ‘sand grabber’ tines or spikes 9 as known in the art. However, a sinker according to the present invention may be provided with or without sand grabbing tines.

Where in the foregoing description reference has been made to integers or components having known equivalents thereof, those integers are herein incorporated as if individually set forth.

1. A fishing sinker comprising:
a weight;
an elongate member extending from the weight, a proximate end of the elongate member attached to the weight; and
an attachment point at an opposite distal end of the elongate member for attaching a fishing line,
wherein the elongate member is configured to receive a baited hook from a side of the elongate member.

2. The fishing sinker as claimed in claim 1, wherein the weight is a solid unitary mass without any longitudinal aperture therethrough.

3. The fishing sinker as claimed in claim 1, wherein the mass of the weight is much greater than the mass of the elongate member so that a centre of mass of the sinker in a longitudinal direction of the sinker is at the weight.

4. The fishing sinker as claimed in claim 1, wherein the mass of the elongate member is less than half the mass of the weight.

5. The fishing sinker as claimed in claim 1, wherein the mass of the elongate member is less than 25% of the mass of the weight.

6. The fishing sinker as claimed in claim 1, wherein the length of the elongate member extending from the is 80 mm to 140 mm.

7. The fishing sinker as claimed in claim 1, wherein the weight presents a nose cone shape to provide an aerodynamic profile.

8. The fishing sinker as claimed in claim 1, wherein the elongate member presents a laterally facing open recess for receiving a baited hook from a side of the elongate member.

9. The fishing sinker as claimed in claim 8, wherein the elongate member comprises a tubular part attached to the weight and an elongate part extending from the tubular part, the elongate part presenting the recess for receiving a baited hook from a side of the elongate member.

10. The fishing sinker as claimed in claim 9, wherein the cross section of the elongate part corresponds with a portion of the cross section of the tubular part.

11. The fishing sinker as claimed in claim 9- or 10, wherein the elongate member is formed from length of tube with a side portion removed, the tubular part of the elongate member comprising a full cross section of the tube and the elongate part comprising a portion of the cross section of the tube.

12. The fishing sinker as claimed in claim 9, wherein the elongate part comprises one-quarter to three-quarters of the cross section of the tubular part and is preferably one-half of the cross section of the tubular part.

13. The fishing sinker as claimed in claim 11, wherein the tube comprises a circular cross section or a square cross section.

14. The fishing sinker as claimed in claim 9, wherein the distal end of the elongate member is open.

15. The fishing sinker as claimed in claim 1, wherein the elongate member is configured to operate as a vane, to cause the sinker to rise to the surface during retrieval.

16. The fishing sinker as claimed in claim 9, wherein the tubular part extends from the weight to present a rearwardly facing recess for receiving a fish attractant.

17. The fishing sinker as claimed in claim 16, comprising a sponge received in the rearwardly facing recess for receiving a liquid fish attractant.

18. The fishing sinker as claimed in claim 16, wherein the rearwardly facing recess has a volume of 1 to 5 millilitres

19. The fishing sinker as claimed in claim 1, wherein the attachment point is an aperture through the elongate member at the distal end of the elongate member.

20. The fishing sinker as claimed in claim 1, wherein the weight has a mass of 2 to 8 ounces.

21. The fishing sinker as claimed in claim 1, wherein the elongate member is formed from aluminium.

22. The fishing sinker as claimed in claim 1, wherein the sinker comprises a hook attached to the sinker to trail slightly behind or towards a weight end of the sinker during retrieval to configure the sinker as a fishing lure during retrieval.

23. The fishing sinker as claimed in claim 22, wherein the hook is attached to the attachment point by a line separate from a main fishing line attached to the attachment point during use.

24. A method of fishing using a sinker as claimed in claim 1, wherein the method comprises:
attaching a fishing line to the attachment point with a hook attached to the line or a secondary line attached to the sinker, and applying bait to the hook;
placing the baited hook and the sinker on the elongate member from a side of the elongate member,
wrapping tape with dissolvable adhesive around the hook and bait and elongate member to secure the hook and bait to the sinker,
casting the sinker with attached baited hook a distance into a body of water using a fishing rod and reel, whereby the sinker sinks to the bottom of the body of water and the tape adhesive dissolves in the water, allowing the baited hook to release from the sinker.

25. The method as claimed in claim 24, wherein the method comprising retrieving the line, hook and sinker using the rod and reel, causing the sinker to lift to the surface of the water during retrieval.

26. The method as claimed in claim 24, wherein the tape has the adhesive applied to one side, and wrapping the tape around the elongate member adheres the tape to itself to attach the baited hook to the elongate member.

27. The method as claimed in claim 26, wherein the adhesive is activated by wetting.

28. The method as claimed in claim 24, wherein the tape is biodegradable.

29. A method of manufacturing a sinker as claimed in claim 1, the method comprising:
providing a parent length of tube, and cutting the parent tube into pieces, wherein each piece forms the elongate member;
removing a side portion from the piece of tube to form the elongate member comprising a tubular part and an elongate part;
adding the attachment point to the distal end of the elongate member; and
attaching the tubular part of the elongate member to the weight.

30. The method as claimed in claim 29, wherein the step of attached the tubular part to the weight comprises placing an end portion of the tubular part in a mould and poring molten material into the mould to form the weight moulded to the tubular part.
